(19) United States
(12) Patent Application Publication
(10) Pub. No.: US 2019/0327956 A1
(43) Pub. Date: Oct. 31, 2019

(54) DISPLAY

(71) Applicant: Darrell Duane Bartel, Waupaca, WI (US)

(72) Inventor: Darrell Duane Bartel, Waupaca, WI (US)

(21) Appl. No.: 16/381,752

(22) Filed: Apr. 11, 2019

Related U.S. Application Data
(60) Provisional application No. 62/762,338, filed on Apr. 30, 2018.

(51) Int. Cl. A01M 31/06; G09F 7/22

(52) U.S. Cl. CPC A01M 31/06; G09F 2007/1804; G09F 7/22

(57) ABSTRACT

A display assembly includes a cylindrical rod having a first end and a second end; a panel holder defining a slot and a first passageway; and a panel disposed partially disposed within the slot. The first end of the cylindrical rod is within the first passageway such that the panel and panel holder are rotatable with respect to the rod. Accordingly, when the second end of the rod is inserted into the ground, the panel and panel holder are rotatable about a generally vertical axis

### CROSS-REFERENCE TO RELATED APPLICATION

This application claims the benefit of U.S. Provisional Patent Application No. 62/762,338, filed Apr. 30, 2018, and which is hereby incorporated by reference in its entirety.

### TECHNICAL FIELD

This disclosure relates to displays such as a display of the silhouette of an animal or a three-dimensional object or a sign or to form a decoy.

### BACKGROUND

Decoys have been produced in many forms and fall primarily under two categories: static decoys and motion decoys. The primary intent of both types of decoys is to attract a live bird for observation or hunting purposes. Stationary or static decoys represent the general shape, size, color and feather pattern of a live bird. These decoys are very basic and rely on the ability of a passing bird to recognize the shape as a fellow bird. Motion decoys employ electric motors or manually-operated mechanical systems to cause movement of all or part of a decoy to imitate the movements of a live bird. The movements of the decoy are used to catch the attention of a passing bird.

### SUMMARY

A display assembly includes a cylindrical rod having a first end and a second end; a panel holder defining a slot and a first passageway; and a panel disposed partially disposed within the slot. The first end of the cylindrical rod is within the first passageway such that the panel and panel holder are rotatable with respect to the rod. Accordingly, when the second end of the rod is inserted into the ground, the panel and panel holder are rotatable about a generally vertical axis.

The wind will cause this rotation of the panel. In one embodiment, the panel is a silhouette-style decoy for use in hunting or attracting birds. The rotation caused by the wind enhances the realism of the decoy and thus enhances the effectiveness of the decoy. Thus, when the panel is a decoy, the display assembly enables movement with less complexity, weight, and expense than prior art decoys, which rely on motors or other mechanical devices to cause the movement. The display may also be used for other uses, such as a sign that moves and thereby attracts the attention of passers-by.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a top view of a kit of parts for assembling a display, the parts including first and second members, a nut, and a bolt;

FIG. 2 is a schematic, front view of a display produced using the kit of parts and including a panel;

FIG. 3 is a schematic, cross-sectional, side view of the display;

FIG. 4 is a schematic, front view of the display with an alternative panel configuration;

FIG. 5 is a schematic, top view of an alternative member for use in a display;

FIG. 6 is a schematic, cross-sectional side view of an alternative display configuration using the alternative member of FIG. 5;

FIG. 7 is a schematic, perspective view of a display of FIG. 5 with a turkey fan and bracket; and

FIG. 8 is a schematic, side front view of a display with yet another panel configuration.

### DESCRIPTION OF THE PREFERRED EMBODIMENTS

Referring now to FIGS. 1-3, wherein like reference numbers refer to like components, a kit for a display 8 includes a left body portion, i.e., a first member 10; a right body portion, i.e., a second member 11; a fastener, namely bolt 17; a shoulder nut 16; a panel 18; and a cylindrical rod 20. The first member 10 defines a first thin portion 10a, a first thick portion 10b, a first aperture 12, and a first trough 14. The second member 11 defines a second thick portion 11b, a second thin portion 11a, a second aperture 13, and a second trough 15. The first and second members 10, 11 in the embodiment depicted are disks. The circular back face 22, 24 of each member 10, 11 is flat. The circular front face 28, 32 of each member 10 and 11 is stepped to result in the thin portions 10a, 11a.

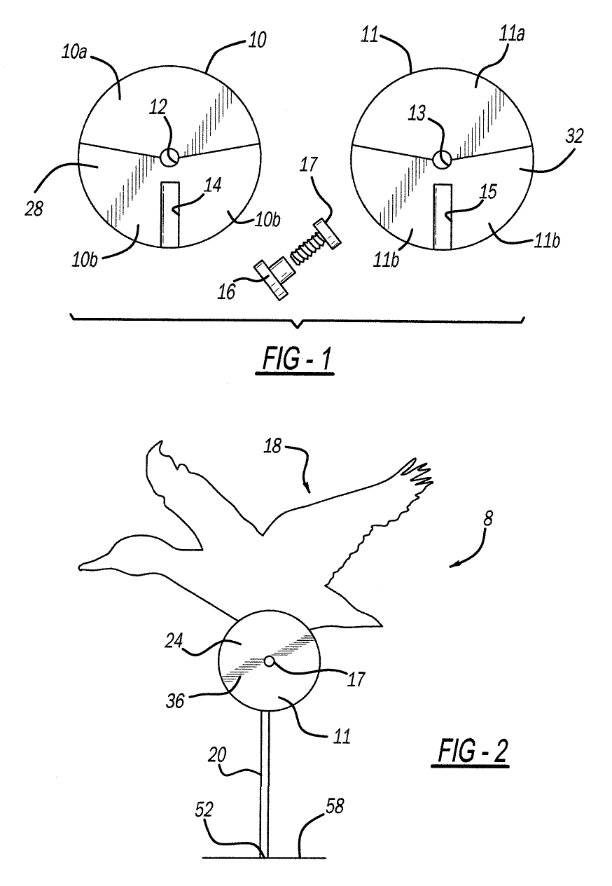

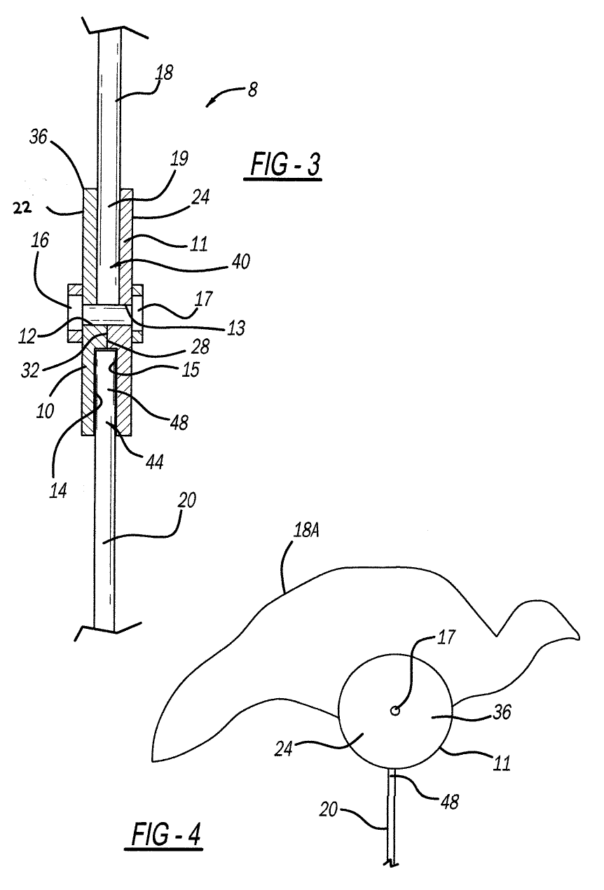

Referring specifically to FIGS. 2 and 3, the first and second members 10, 11 are positioned such that the front faces 28, 32 face one another, the first thick portion 10b contacts or abuts the second thick portion 11b, and the centrally located apertures 12, 13 are aligned with one another. The bolt 17 extends through the apertures 12, 13 and engages the shoulder nut 16 to secure the first and second members 10, 11 together. The first and second members 10, 11, bolt 17, and nut 16 cooperate to form a panel holder 36.

The panel holder 36 defines a slot 40. More specifically, the first and second thin portions 10a, 11a define slot 40 therebetween. The panel 18 is partially disposed within the slot 40 and is clamped between the first member 10 and the second member 11 with the clamping force provided by the nut 16 and bolt 17. Troughs 14 and 15 are aligned and cooperate to form a passageway 44. The cylindrical rod 20 has a first end 48 and a second end 52. The first end 48 of the cylindrical rod 20 is inserted into the passageway 44; the second end 52 of the rod 20 may be driven into the ground 58. The rod 20 thus supports the panel holder 36 and the panel 18 above the ground 58 such that the slot 40 is upwardly open. The passageway 44 formed by the troughs 14 and 15 is preferably cylindrical and has a diameter larger than the diameter of the rod 20 so that the panel 18 and panel holder 36 are rotatable with respect to the rod 20 about a vertical axis and can turn in a wind.

The first and second members 10, 11 can be made of any suitable material but preferably are made of one half inch thick, five and three quarters of an inch to six inches in diameter high density polyethylene disks that are routed to have stepped faces as depicted in FIG. 1. The fastener used to clamp the body portions together is preferably the shoulder nut and bolt shown in FIG. 1 but any suitable fastener can be used such as an ordinary nut and bolt, a screw or a rivet. The rod 20 is preferably galvanized steel, but may be any material within the scope of the claims. The use of a galvanized steel rod 20 with high density polyethylene disks for members 10, 11 produces a low coefficient of friction between the rod 20 and the panel holder 36 and produces desirable rotation in wind.

The panel 18 may be a silhouette of a bird, such as the duck shown in FIG. 2, so that the display 8 functions as a decoy. The panel 18 can be a silhouette of an animal such as and without limitation thereto, a duck, a crow, a turkey, a dog, a bear, a pig or a raccoon. The panel 18 can be a silhouette of any three-dimensional object such as and without limitation thereto, a house or a car. The panel can be a sign such as and without limitation thereto a for sale sign or an advertisement. Differently-configured panels may be employed with a single panel holder 36. As shown in FIG. 4, wherein like reference numbers refer to like components from FIGS. 1-3, another panel 18A is inserted within the slot (shown at 40 in FIG. 3). Panel 18A is a silhouette of a wild turkey.

Referring now to FIG. 5, wherein like reference numbers refer to like components from FIGS. 1-4, therein is shown a member 110 similar to member 10 of FIG. 1 but showing an alternative thin portion 110A and thick portion 110B and an additional trough 119 across the lower portion of member 110. The trough 119 is perpendicular to trough 114. Trough 114 is substantially similar in size, placement, and function to the trough shown at 14 in FIGS. 1 and 3. More specifically, the thick portion 110B defines trough 119 and trough 114. The member 110 defines aperture 12.

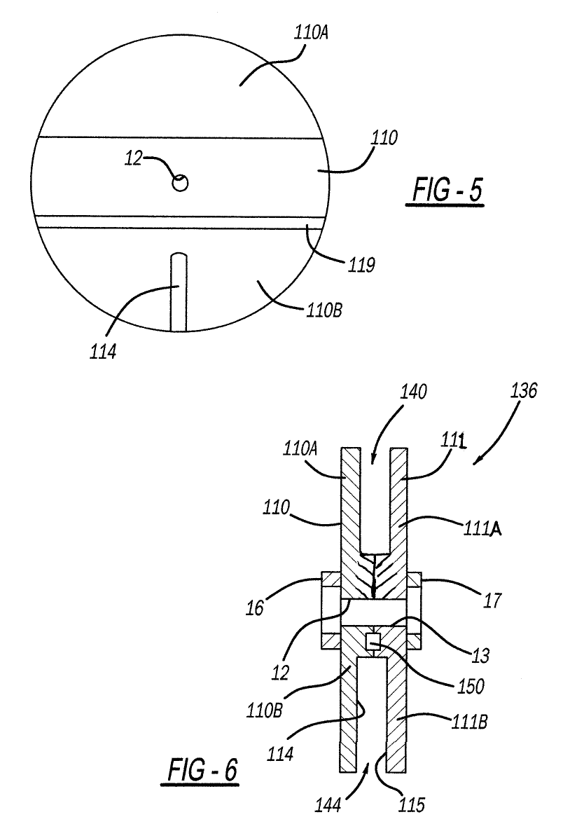

Referring to FIG. 6, wherein like reference numbers refer to like components from FIGS. 1-5, a panel holder 136 is formed by member 110 and member 111 in a manner similar to the panel holder shown at 36 in FIGS. 2 and 3. Member 111 is identical to member 110, and includes a thin portion 111A, a thick portion 111B, a trough 119, a trough 115, and an aperture 13. A bolt 17 extends through apertures 12, 13 and engages nut 16 to clamp the members 110, 111 together. Thick portions 110B, 111B contact one another. Troughs 114, 115 cooperate to form a first passageway 144 that is substantially similar to the passageway shown at 44 in FIGS. 2 and 3. The troughs 119 of each member 110, 111 cooperate with each other to define a second passageway 150 perpendicular to the first passageway 144. Thin portions 110A, 111A cooperate to define a slot 140 therebetween for holding a panel or other object.

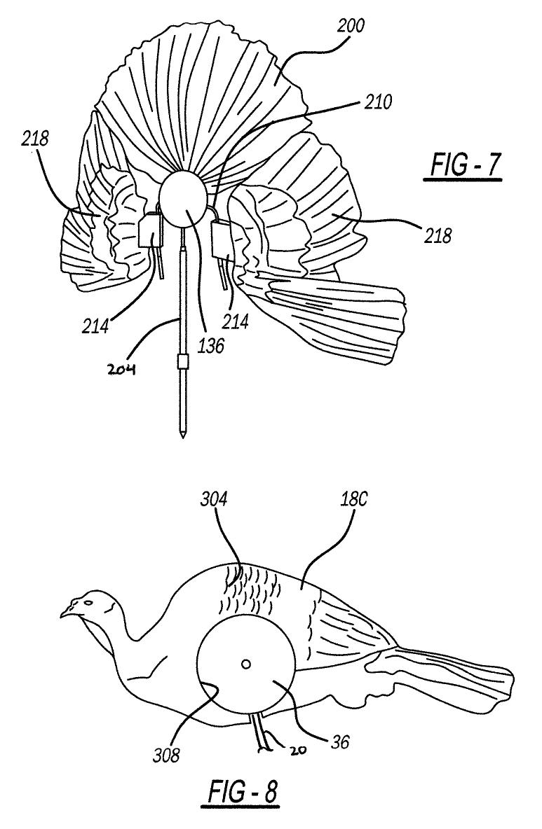

FIG. 7, wherein like reference number refers to like components from FIGS. 1-6, depicts the panel holder 136 in use with a display. Referring to FIGS. 6 and 7, a turkey tail fan 200 is inserted in the slot 140. A bracket 210 extends through the second passageway 150. In the embodiment depicted, the bracket 210 is a U-shaped rod that protrudes from two sides of the panel holder 136. The display includes first and second clips 214; each clip 214 is on a respective side of the panel holder 136. Each clip 214 secures a respective turkey wing 218 to the bracket 210.

A rod 204 is inserted into the first passageway 144. In the embodiment depicted, the portion of the rod 204 inserted into the first passageway 144 is cylindrical, but the rod 210 also includes a tapered portion to facilitate insertion into the ground.

Referring to FIG. 8, wherein like reference numbers refer to like components from FIGS. 1-7, yet another panel 18C is shown in use with the panel holder 36 to form a display. The panel 18C has two parallel, planar sides, only one of which is shown in FIG. 8. The sides include graphics 304 printed thereon. In the embodiment depicted, the panel 18C has the general shape of a turkey and the graphics 304 is an image of a turkey. The graphics 304 are preferably in color, but may be black and white or grayscale within the scope of the invention.

The panel 18C also includes a generally circular cut-out or cavity 308 that at least partially contains the panel holder 36. The panel 18C shown is approximately 6 millimeters thick, ten inches in height, and between twenty-six and twenty-seven inches long, though other dimensions may be employed within the scope of the claims. The panel 18C comprises black polyvinyl chloride, foam cored. Although the graphics include the image of a turkey in the embodiment depicted, any graphics may be employed within the scope of the claims.

While the best modes for carrying out the invention have been described in detail, those familiar with the art to which this invention relates will recognize various alternative designs and embodiments for practicing the invention within the scope of the appended claims.

1. A display assembly comprising:
a cylindrical rod having a first end and a second end;
a panel holder defining a slot and a first passageway; and
a panel disposed partially disposed within the slot;
wherein the first end of the cylindrical rod is within the first passageway.

2. The display assembly of claim 1, wherein the panel holder includes a first member, a second member, and a fastener;
wherein the first member defines a first thick portion, a first thin portion, a first aperture, and a first trough;
wherein the second member defines a second thick portion, a second thin portion, a second aperture, and a second trough; and
wherein the fastener extends through the first aperture and the second aperture thereby securing the first member to the second member.

3. The display of claim 2, wherein the first thick portion abuts the second thick portion;
wherein the first thin portion and the second thin portion cooperate to define the slot therebetween; and
wherein the first trough and the second trough cooperate to define the first passageway.

4. The display of claim 3, wherein the first and second members are disk-shaped.

5. The display of claim 1, wherein the first passageway is cylindrical and has a first diameter;
wherein the rod has a second diameter;
wherein the second diameter is smaller than the first diameter such that the panel holder is rotatable with respect to the rod.

6. The display of claim 1, wherein the panel holder defines a second passageway extending through the panel holder;
said second passageway being substantially perpendicular to the first passageway.

7. The display of claim 6, further comprising a bracket extending through the second passageway.

8. The display of claim 7, further comprising a first clip mounted to the bracket on a first side of the panel holder, and a second clip mounted to the bracket on a second side of the panel holder.

9. The display of claim 1, wherein the panel is a silhouette of an animal, a sign, a decoy, or a turkey tail.

10. The display of claim 9, wherein the panel includes an image of a bird printed thereon.

11. The display of claim 10, wherein the panel comprises polyvinyl chloride.

12. The display of claim 11, wherein the panel is foam cored.

13. The display of claim 1, wherein the panel holder is high density polyethylene; and
wherein the rod is galvanized steel.

14. A kit of parts for a display comprising:
a first member having a first thick portion, a first thin portion, a first aperture, and a first trough;
a second member having a second thick portion, a second thin portion, a second aperture, and a second trough;
a fastener extendable through the first aperture and the second aperture thereby to secure the first member to the second member such that the first and second thin portions define a slot therebetween, and the first and second troughs cooperate to define an passageway; and
a rod being insertable into the passageway.

15. The kit of parts of claim 14, wherein the first and second members are disk-shaped.

16. The kit of parts of claim 14, further comprising a panel that is insertable into the slot.
